(19) United States
(12) Patent Application Publication
(10) Pub. No.: US 2026/0136030 A1
(43) Pub. Date: May 14, 2026

(54) PROCESSING A MULTI-LAYER VIDEO STREAM

(71) Applicant: V-NOVA INTERNATIONAL LIMITED, London (GB)

(72) Inventors: Simone FERRARA, London (GB); Stefano BATTISTA, London (GB); Daniele SPARANO, London (GB)

(21) Appl. No.: 19/120,149

(22) PCT Filed: Oct. 13, 2023
(86) PCT No.: PCT/GB2023/052671

§ 371 Date: Apr. 10, 2025

(30) Foreign Application Priority Data
Oct. 14, 2022 (GB) 2215188.0

(51) Int. Cl. H04N 19/33; H04N 19/154; H04N 19/169; H04N 19/196

(52) U.S. Cl. CPC H04N 19/33; H04N 19/154; H04N 19/188; H04N 19/196

(57) ABSTRACT

Video processing methods are described. In particular, examples are presented of parsing multi-layer video streams. Parsers for existing non-layered video streams are modified to parse multi-layer video streams to allow flexible encoding and decoding of multi-layer video.

### TECHNICAL FIELD

The present invention relates to the processing of a multi-layer video stream. In particular, the present invention relates to the parsing of a multi-layer video stream, e.g. during a decoding process.

### BACKGROUND

Multi-layer video coding schemes have existed for a number of years but have experienced problems with widespread adoption. Much of the video content on the Internet is still encoded using H.264 or MPEG-4 Part 10, Advanced Video Coding (MPEG-4 AVC), with this format being used for between 80-90% of online video content. This content is typically supplied to decoding devices as a single video stream that has a one-to-one relationship with available hardware and/or software video decoders, e.g. a single stream is received, parsed and decoded by a single video decoder to output a reconstructed video signal. Many video decoder implementations are thus developed according to this framework.

Existing multi-layer coding schemes include the Scalable Video Coding (SVC) extension to H.264, Scalable extensions to H.265 or MPEG-H Part 2 High Efficiency Video Coding (SHVC), and newer standards such as MPEG-5 Part 2 Low Complexity Enhancement Video Coding (LCEVC). While H.265 is a development of the coding framework used by H.264, LCEVC takes a different approach to scalable video. SVC and SHVC operate by creating different encoding layers and feeding each of these with a different spatial resolution. Each layer encodes the input according to a normal AVC or HEVC encoder with the possibility of leveraging information generated by lower encoding layers. LCEVC, on the other hand, generates one or more layers of enhancement residuals as compared to a base encoding, where the base encoding may be of a lower spatial resolution.

One reason for the slow adoption of multi-layer coding schemes has been the difficulty adapting existing and new decoders to process multi-layer encoded streams. As discussed above, video streams are typically single streams of data that have a one-to-one pairing with a suitable decoder, whether implemented in hardware or software or a combination of the two. Client devices and media players, including Internet browsers, are thus built to receive a stream of data, determine what video encoding the stream uses, and then pass the stream to an appropriate video decoder. Within this framework, multi-layer schemes such as SVC and SHVC have typically been packaged as larger single video streams containing multiple layers, where these streams may be detected as “SVC” or “SHVC” and passed atomically to an SVC or SHVC decoder for reconstruction. This approach though often mitigates some of the benefits of multi-layer encodings. Hence, many developers and engineers have concluded that multi-layer coding schemes are too cumbersome and return instead to a multicast of single H.264 video streams.

It is thus desired to obtain an improved method and system for decoding multi-layer video data that overcomes some of the disadvantages discussed above and that allows more of the benefits of multi-layer coding schemes to be realised.

The paper “The Scalable Video Coding Extension of the H.264/AVC Standard” by Heiko Schwarz and Mathias Wien, as published in IEEE Signal Processing Magazine 135, March 2008, provides an overview of the SVC extension.

The paper “Overview of SHVC: Scalable Extensions of the High Efficiency Video Coding Standard” by Jill Boyce, Yan Ye, Jianle Chen, and Adarsh K. Ramasubramonian, as published in IEEE Transactions on Circuits and Systems for Video Technology, VOL. 26, NO. 1, January 2016, provides an overview of the SHVC extensions.

The decoding technology for LCEVC is set out in the Draft Text of ISO/IEC FDIS 23094-2 as published at Meeting 129 of MPEG in Brussels in January 2020, as well as the Final Approved Text, and WO 2020/188273 A1. FIG. 29B of WO 2020/188273 A1 describes a hypothetical reference decoder where a demuxer provides a base bitstream to a base decoder and an enhancement bitstream to an enhancement decoder.

WO 2020/016562 A1 describes methods of decoding a bitstream. In examples, a version of an original signal is encoded using a base coding standard and one or more layers of a residual stream may be encoded using an enhancement encoding. In a first example, the encoded residual stream or streams are encapsulated within a Supplemental Enhancement Information (SEI) message. In a second example, the encoded residual stream or streams may be transmitted as a series of Network Abstraction Layer (NAL) units that are interleaved with NAL units of an encoded base stream.

With multi-layer streams there is also a general problem of stream management. Different layers of a multi-layer stream may be generated together or separately, and may be supplied together or separately. It is desired to have improved methods and systems for decoding of these multi-layer streams. For example, it is desired to allow content distributors to easily and flexibility modify video quality by adding additional layers in a multi-layer scheme. It is also desired to be able to flexibly re-multiplex multi-layer video streams without breaking downstream single-layer or multi-layer decoding.

There is also a problem of supplying multi-layer streams as static file formats. For example, video streams may be read from fixed or portable media, such as solid-state devices or portable disks, or downloaded and stored as a file for later viewing. It is difficult to support the carriage of multi-layer video with existing file formats, as these file formats typically assume a one-to-one mapping with media content and decoding configurations, whereas multi-layer streams may use different decoding configurations for different layers. Changes in file formats often do not work practically, as they require updates to decoding hardware and software and may affect the decoding of legacy formats.

All of the above publications set out above are to be incorporated by reference herein.

### SUMMARY OF THE INVENTION

Aspects of the present invention are set out in the appended independent claims. Variations of these aspects are set out in the appended dependent claims.

### BRIEF DESCRIPTION OF THE FIGURES

FIG. 1 is a schematic diagram showing a first example of a multi-layer video stream comprising interleaved NAL units.

FIG. 2 is a schematic diagram showing a second example of a multi-layer video stream comprising base layer NAL units and enhancement SEI messages.

FIG. 3 is a flow diagram showing an example method of parsing a multi-layer video stream.

FIG. 4 shows a set of bit configurations for NAL header data according to an example.

FIGS. 5 and 6 are schematic diagrams respectively showing an example multi-layer encoder and decoder configuration.

FIG. 7 is a schematic diagram showing certain data processing operations performed by an example multi-layer encoder.

### DETAILED DESCRIPTION

Certain examples described herein allow decoding devices to be easily adapted to handle multi-layer video coding schemes. Certain examples are described with reference to an LCEVC multi-layer video stream, but the general concepts may be applied to other multi-layer video schemes.

Different examples are presented. In one set of examples, a method of parsing a multi-layer video stream is described. The method may be seen as a way of adapting an existing parser to handle a multi-layer video stream. The existing parser may be initially configured to parse a non-layered video stream, e.g. a conventional video encoding whereby a single stream of NAL units contains all the data for a decoding of a video signal. In the examples, the parser is modified to handle a multi-layer video stream where data for decoding a video signal is received across different streams of NAL units or via different transport mechanisms. The examples thus allow multi-layer video streams to be stored and/or transmitted as if they were conventional non-layer video streams.

The present examples enable the carriage of a base video bitstream and an enhancement video bitstream within a single “track”, e.g. within a data structure that resembles a bitstream for just the base video bitstream. For example, a single bitstream carrying both a base video bitstream and an enhancement video bitstream may have a single Packet Identifier (PID) within a transport or file stream—thus resembling conventional non-enhanced bitstreams with a single PID.

The present examples provide an alternative approach to so-called “dual track” carriage of base and enhancement bitstreams. In the “dual track” case, a base video bitstream and an enhancement video bitstream may be transmitted and/or stored as two separate bitstreams, e.g. with separate PIDs or in separate tracks.

The present examples may be applied to multi-layer video bitstreams that are configured according to the specifications of an MPEG-2 Transport Stream (TS) and/or an MPEG-4 File Format (FF). Reference to a multi-layer video bitstream may comprise reference to a multi-layer video bitstream that is suitable for carriage via any one of: MPEG-2 TS, MPEG-4 FF, Dynamic Adaptive Streaming over Hypertext Transfer Protocol (DASH), or Common Media Application Format (CMAF).

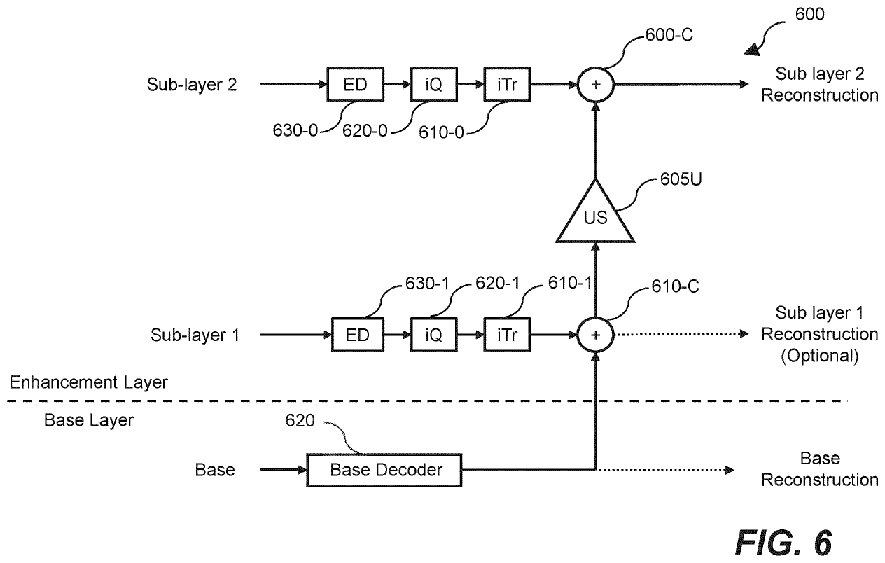

The present examples may be applied to enhancement bitstream that conforms to standard specification ISO/IEC 23094-2—so-called MPEG-5 Low Complexity Enhancement Video Codec (LCEVC). In general, the enhancement bitstream is configured to enhance a standalone “base” bitstream, where the base bitstream is a video encoding that may be independently decoded (and viewed if desired) by a base decoder. The enhancement bitstream may comprise a so-called residual bitstream where frames reconstructed from the enhancement bitstream comprises residual frames (i.e., sets of frame residuals) that are combined with frames decoded from the base bitstream to enhance the quality of the base bitstream. In certain cases, certain layers of residual frames may be combined with upsampled reconstructed signals. For example, in LCEVC there is a first enhancement layer, which may be at the resolution of the reconstructed decoded base frame and is able to correct for encoding artifacts, and a second enhancement layer, which is at a higher resolution than the reconstructed decoded base frame, where a residual frame at the higher resolution may be combined following the upsampling of a reconstructed decoded base frame that is corrected with a residual frame from the first enhancement layer. This process is described in more detail with reference to FIGS. 5 to 7 below.

In enhancement specifications such as LCEVC, an enhancement bitstream is defined that enhances a separately defined video bitstream (the base). A process is defined to combine the two bitstreams to produce an enhanced video output. As the two bitstreams may be independently decoded, carriage and storage of base and enhancement bitstreams may be performed by a dual-track approach with two separate streams (PIDs or tracks) which can be linked together with a dependency mechanism. The use of such an approach and mechanism may be facilitated by existing dependency mechanisms, for example those already present in MPEG4 FF and already used for carriage of other standard formats. The dual-track approach may facilitate transport of a base bitstream and an enhancement bitstream in two separate physical channels (e.g., the base bitstream via an over-the-air channel and the enhancement bitstream via a broadband channel). However, the dual-track approach may not be suitable for all implementations. For example, there are many commercial media player implementations, particularly for video streaming, where the media player can only support playback of a single stream. Additionally, packaging the bitstream as a single stream may simplify the design of future media players and allow for more widespread adoption of multi-layer video streams. Hence, there are technical benefits to supporting both single and dual-track approaches. The present examples thus consider technical solutions that may support single track approaches.

In certain examples described herein, a base bitstream and an enhancement bitstream, which may be referred to as a multi-layer video bitstream, is able to be carried and/or stored as a single bitstream. For example, this may comprise a single MPEG2 TS transport stream with a single PID or a single MPEG4 FF track. The layers of such a multi-layer bitstream may comprise the “base” as a first layer and one or more enhancement layers (LCEVC has an option of up to two enhancement layers). In certain examples, the base bitstream is generated according to one of the following MPEG video coding specifications: Advanced Video Coding (AVC—also referred to as ISO/IEC 14496-10 or H.264), High Efficiency Video Coding (HEVC—also referred to as ISO/IEC 23008-2 or H.265), and Versatile Video Coding (VVC—also referred to as ISO/IEC 23090-3 or H.266). Other past and future video coding specifications may also be supported due to the independence of the enhancement layers—they may be generated based on any input frame from a base layer decoding. As one example, a single “track” multi-layer video stream may comprise a base bitstream (e.g., VVC) plus an LCEVC bitstream as a single-track in terms of MPEG2 TS PID or MPEG4 FF track.

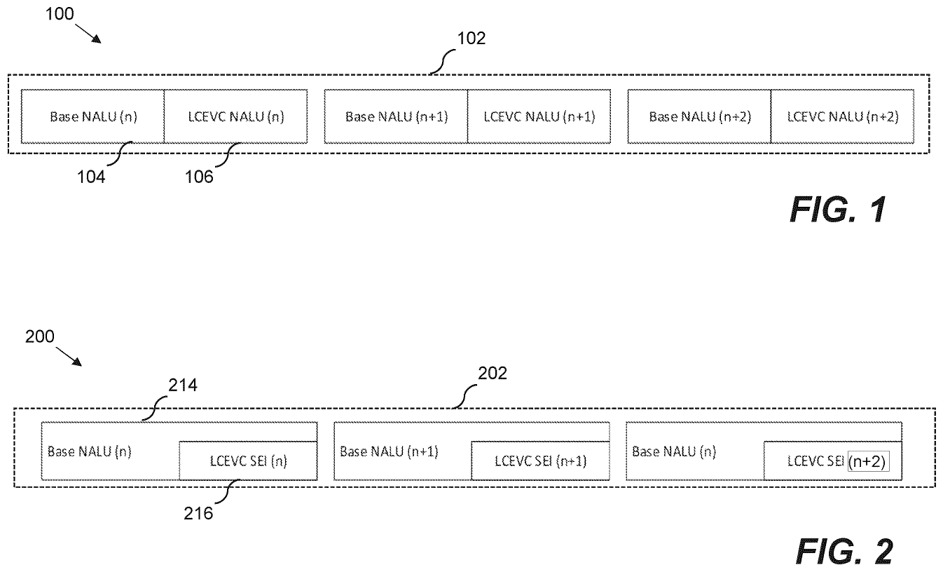

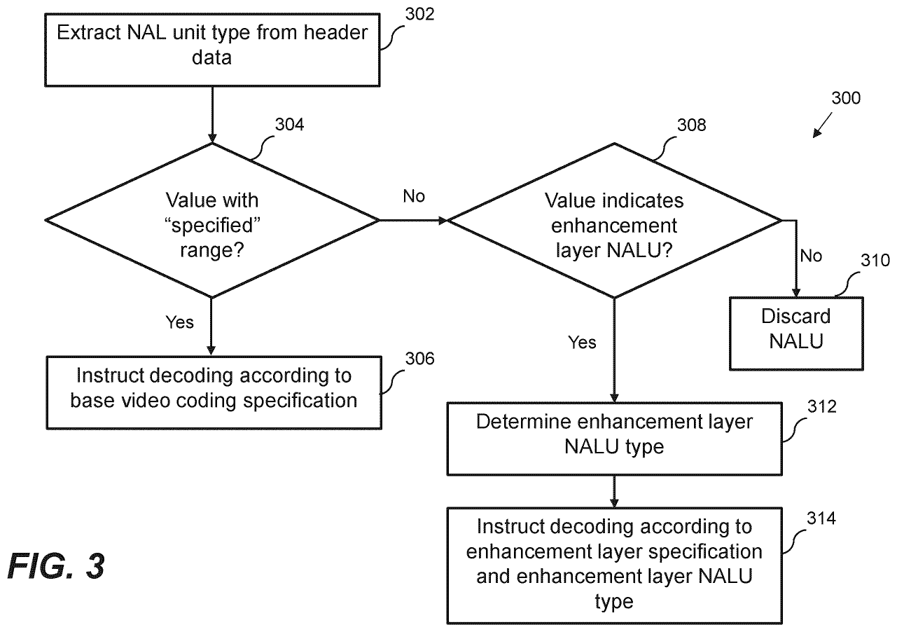

FIGS. 1 and 2 respectively show two alternative implementations of a single-track multi-layer video stream. Both implementations provide a complete multi-layer video stream comprising a base bitstream and an enhancement bitstream. FIG. 1 shows an example with interleaved NAL units. FIG. 2 shows an example where the enhancement bitstream is carried in a set of SEI messages.

In the example 100 of FIG. 1, NAL units for the base bitstream 104 and the enhancement bitstream 106 (in this case LCEVC) are interleaved to provide a single-track multi-layer video stream 102. As enhancement bitstreams may be generated for a variety of different base video coding specifications, each base video coding specification may define its own NAL unit syntax and this syntax may vary between specifications. The NAL units for the enhancement bitstream 106 may be NAL units as defined in section 7.3.2 of ISO/IEC 23094-2.

In present examples, the format of the enhancement NAL units may be specified to allow for unambiguous detection even when parsed according to the NAL unit syntax of a base bitstream, where the base bitstream may vary according to a number of different base specifications (e.g., the base NAL units may be formatted and processed according to any one of the AVC, HEVC or VVC NAL unit syntaxes). This property allows for an “interleaved” single stream of base plus enhancement, where enhancement NAL units are inserted among base NAL units, within the same NAL unit sequence (e.g. as shown in FIG. 1). In the resulting interleaved single stream, each Access Unit, defined as the set of NAL units that result in each decoded picture, will contain both the enhancement NAL units (e.g., an LCEVC Access Unit contains only one LCEVC NAL unit) and the base NAL units relevant for the specific Access Unit.

FIG. 2 shows an alternative to the interleaved approach of FIG. 1. In the example 200 of FIG. 2, enhancement data is encapsulated as NAL units, e.g. as defined in section 7.3.2 of ISO/IEC 23094-2, which is then further encapsulated with metadata information 216 for base NAL units 214 to generate a single-track multi-layer video bitstream 102. In specific examples, the metadata information 216 may comprise SEI messages, e.g. as defined by any one of AVC, HEVC and VVC. Hence, in FIG. 2 NAL units are employed as basic data units and the type of NAL unit identified as Supplemental Enhancement Information (SEI) is used to embed an enhancement NAL unit stream. The SEI messages may be regular size or large size SEI messages. In both cases of FIG. 1 and FIG. 2, the encapsulation of the bitstream may be within MPEG2 TS “.ts” and MPEG4 FF “.mp4” data structures.

In certain examples described herein a parser for a base bitstream is modified to process a multi-layer video bitstream, such as one of the bitstream examples shown in FIGS. 1 and 2. A parser may comprise one or more of software and hardware arranged to process data received from one or more of a file source and a network source. For example, the parser may receive bits read from a data storage device via a file system of a computing device and/or bits output by a network processing stack configured to process data received over a network connection (e.g., wired or wireless). The parser may be located at the beginning of a media processing pipeline before one or more decoding components. The one or more decoding components may comprise implementations of coding-decoding components—i.e. codecs. These codecs may be implemented via computer program code being processed by a processor and/or via specifically configured electronic hardware (such as Application Specific Integrated Circuits—ASICs—and Field Programmable Gate Arrays—FPGAs). Often codecs may integrate hardware-accelerated computations, i.e. computations that use specially configured electronic chips to speed up operations performed during decoding. In certain cases, a parser may comprise part of a specific codec (e.g., an AVC parser may comprise a first stage in an AVC codec); in other cases, a parser may be provided separately.

In a comparative case, a comparative (e.g., “unmodified”) parser for video coding receiving bits of data structured according to the syntax of a particular video coding standard. For example, an AVC parser may form an early or first component in an AVC decoding pipeline. This comparative parser may receive NAL units for a single video coding specification (e.g., AVC, HEVC or VVC NAL units) and process these units to extract encoded data to pass to specific decoding components. For example, a comparative parser may be configured to process NAL units comprising data encoded according to a first video coding specification such as AVC, HEVC, or VVC. The parser may comprise a memory to store header data from NAL units belonging to a video stream and a processor configured to extract a NAL unit type value from the header data for a given NAL unit. Responsive to the NAL unit type value falling within a specified range for first video coding specification, the processor may be configured to instruct the decoding of a payload of the given NAL unit according to the first video coding specification. For example, in normal operation, an AVC, HEVC or VVC parser receives AVC, HEVC or VVC NAL units, inspects the header and performs checks according to the relevant video coding specification before passing encoded data to a decoder that implements the video coding specification. In this comparative case, if the comparative parser encounters a NAL unit with a NAL unit type that is outside of a predefined range (e.g., as discussed later below), the parser is configured to drop or discard the NAL unit (e.g., to not pass the payload data for decoding according to the parser video coding specification). In particular examples, the predefined range is a set of values which are defined as “unspecified” within each video coding specification.

In the present examples, a modified parser is presented wherein the parser is modified or adapted to process a multi-layer video stream. In these examples, the parser may comprise a parser that was previously configured to process a single-track video stream for a single non-layered video coding specification, e.g. an AVC, HEVC or VVC parser. In other examples, a parser may comprise a newly provided parser that is able to manage a multi-layer video stream comprising multiple video coding specifications (e.g., in addition to conventional single-layer video streams). In both cases, a result is a parser that is configured to process a multi-layer video stream comprising multiple video coding specifications.

In general, in the present examples, a parser is configured to parse data associated with received NAL units. The parser is configured to identify whether the NAL unit relates to a first video coding (e.g. “base”) specification or whether the NAL unit relates to an additional enhancement video coding specification. This may be performed by inspecting values with the NAL unit metadata. In certain examples, the NAL units for the enhancement bitstream are configured to indicate a metadata value falling within an unspecified range for the base layer specification for a plurality of different base layer specifications, e.g. as unspecified for two or more of AVC, HEVC, and VVC. In this manner, if an unmodified parser receives a single-track multi-layer video stream, only data from the NAL units for the base bitstream are decoded; data from the NAL units for the enhancement bitstream are discarded as per the first video coding specification—the bitstream may thus be decoded and viewed as just a normal base bitstream. However, a modified parser is configured to additionally pass the data from the NAL units for the enhancement bitstream to an enhancement decoder for decoding (e.g., in parallel) with data for the first video coding specification. In this manner, the modified parser enables the decoding of both the base and enhancement bitstreams and the eventual viewing of a decoded and enhanced video output. In particular examples, different values within an unspecified range for the first video coding specification may have different meanings or uses for the enhancement video coding specification. Hence, a check may be made to determine if the “unspecified” values match one or more values that are defined within the enhancement video coding specification. In this manner, decoding of the NAL unit by an enhancement decoder may occur responsive to the NAL unit type value falling within a predetermined portion of an unspecified range for the first video coding specification (seen as a base layer specification relative to the enhancement video coding specification).

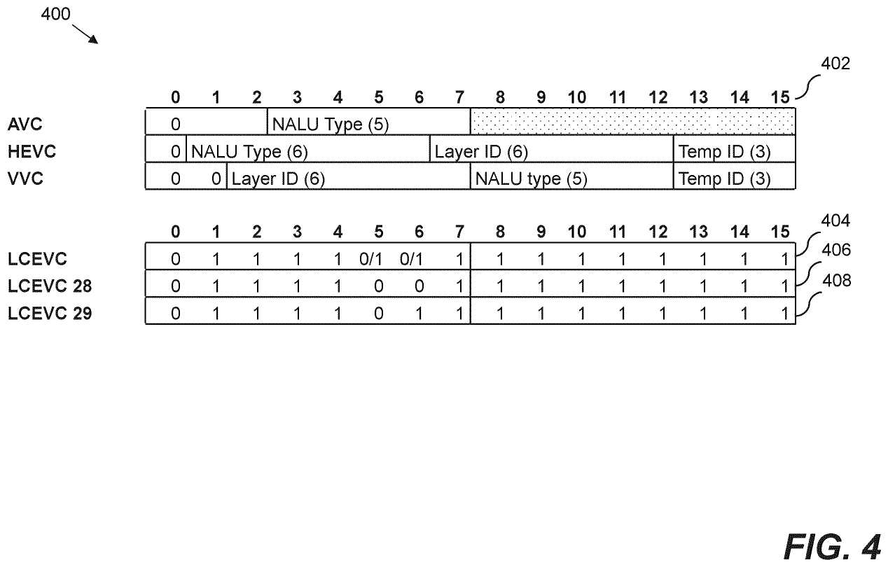

FIG. 3 shows an example method 300 of parsing a multi-layer video stream. In this example, the multi-layer video stream encodes a video signal and comprises a base layer and one or more enhancement layers. The base layer is encoded using a first or base layer specification (e.g., AVC, HEVC, or VVC). The one or more enhancement layers are encoded using an enhancement layer specification. The one or more enhancement layers may comprise one or more sets of frame residuals, a set of frame residuals comprising a difference between a reconstruction derived from a decoded base layer frame and a frame derived from an original video signal at a given level of quality. For example, the one or more enhancement layers may comprise LCEVC layers as described with reference to FIGS. 5 to 7 below.

The example method 300 of FIG. 3 may be performed as part of a parsing operation that is performed by a modified parser for the base layer. The parsing operation may comprise parsing header data for NAL units belonging to the multi-layer video stream. For example, the parsing operation may be performed for each NAL unit 104, 106 in FIG. 1 as they are received at a decoding device. The parsing operation may also be applied to the base NAL unit 214 and an enhancement NAL unit that is extracted from an SEI message 216. The parsing operation may be performed iteratively on each received NAL unit. FIG. 3 shows the sub-operations that may be performed on each NAL unit as part of this parsing operation.

In FIG. 3, at step 302, a NAL unit type value is extracted from the header data for a given NAL unit (i.e., a currently parsed NAL unit). Examples of syntax for NAL unit types for AVC, HEVC, and VVC are set out in more detail later below. The header data may comprise a NAL header. NAL headers may comprise one or two bytes. The extraction of the NAL unit type value may depend on the syntax for the base layer and different base layers may implement different syntax. In many base video specifications, the NAL unit type is represented by a defined nal_unit_type field that is represented by a plurality of bits in the NAL header.

At step 304, the extracted NAL unit type value is compared with one or more ranges of predefined values. In the base layer specification, values may be defined as “specified” or “unspecified”. A range of “specified” values indicates that these values are used (and have meaning within) the base layer specification. Hence, in FIG. 3, at step 306, responsive to the NAL unit type value falling within a specified range for the base layer specification, the decoding of a payload of the given NAL unit is instructed according to the base layer specification (e.g., as per the comparative case described above).

In a non-modified case, if the NAL unit type value does not fall within a specified range for the base layer specification (e.g., is “unspecified”), then the data for the NAL unit is discarded and a next NAL unit is obtained for parsing. However, in the present modifications, indication of an unspecified NAL unit type instigates further parsing of the NAL unit. In particular, at step 308 a determination is made to check whether the NAL unit type value indicates an enhancement layer NAL unit. For example, this may comprise checking whether the NAL unit type value falls within a predetermined portion of an unspecified range for the base layer specification, i.e. has one or more predefined “unspecified” values. In a case of an AVC parser, these one or more predefined “unspecified” values may be 25 or 27; in the case of an HEVC parser, these one or more predefined “unspecified” values may be 60 or 61; in the case of a VVC parser, the one or more predefined “unspecified” values may be 31.

If the determination is negative, i.e. the NAL unit type value does not indicate an enhancement layer NAL unit, then the NAL unit (and its data) may be discarded at step 310 as per unmodified parsing. However, if the determination is positive, i.e. the NAL unit type value does indicate an enhancement layer NAL unit, e.g. by falling within a particular set of unspecified values, then the method 300 proceeds to step 312 where an enhancement layer NAL unit type is determined. In certain cases, different enhancement layer NAL unit types are associated with different unspecified NAL unit type values. The enhancement layer NAL unit type may indicate whether the given NAL unit is associated with an instantaneous decoding refresh picture for the enhancement layer. For example, an instantaneous decoding refresh (IDR) picture may comprise a picture (e.g., data for a set of colour component frames) for which a NAL unit contains a global configuration data block and does not refer to any other picture for operation of the decoding process of this picture and for which no subsequent pictures in decoding order refer to any picture that precedes it in decoding order. In certain cases, an IDR picture shall occur at least when an IDR picture occurs within the base bitstream.

Following step 312, the method 300 proceeds to step 314 where the decoding of the payload of the given NAL unit is instructed according to the enhancement layer specification. The decoding is performed based on the determined enhancement layer NAL unit type. This may comprise passing the NAL unit payload to an enhancement decoder or codec. In one case, the enhancement layer NAL unit type may be passed along with the payload but without the header data. In another case, the complete NAL unit (e.g., header and payload) may be passed to the enhancement decoding process. Responsive to the enhancement layer NAL unit type indicating an instantaneous decoding refresh picture, global configuration data may be extracted from the payload of the given NAL unit, and the global configuration data may be used to decode a plurality of residual frames, where data for the plurality of residual streams are distributed across multiple NAL units in the multi-layer video stream.

In certain implementations, e.g. for VVC, additional base layer metadata may be checked to process the NAL unit, following a positive determination that the NAL unit type falls within one or more values that are unspecified for the base video coding specification but specified for the enhancement video coding specification. For example, as described later below, if the NAL unit type is specified as VVC “unspecified” value “31”, then a VVC layer identifier (the additional base layer metadata) that is defined in the NAL header may be examined to see whether values for the layer identifier fall within a particular set of values, such as “61” or “63” in the example below. If the layer identifier is not “61” or “63” the NAL unit may be discarded. In certain cases, an additional check is made on a value of a reserved zero flag prior to instructing the decoding of the payload of the given NAL unit according to the enhancement layer specification, e.g. the layer identifier is only checked if the reserved zero flag is 1 and the unspecified NAL unit type value is 31. Hence, the modified parser is configured to discard a given NAL unit responsive to values for within the header data falling outside of a predefined set of metadata values.

For completeness, in the following paragraphs examples of NAL unit syntax and example syntax implementations are provided. These are provided as examples only and should not be considered limiting—actual implementations may vary in practice based on context.

The AVC NALU header is defined in ISO/IEC 14496-10, Sec. 7.3.1, with the following syntax:

TABLE 1
AVC NALU header syntax

| Syntax | Descriptor |
|---|---|
| nal_unit_header( ) { | |
| forbidden_zero bit | u(1) |
| nal_ref_idc | u(2) |
| nal_unit_type | u(5) |
| } | |

The NALU type values and semantics for AVC are specified in Table 7-1 of the AVC specification (IS 14496-10). Table 2 summarizes the usage of the AVC NALU types. Since the AVC NALU type is a field of 5 bits, the possible values are from 0 to 31. In this case, values of 21 to 23 are “reserved” and values of 24 to 31 are “unspecified”.

TABLE 2
AVC NALU types

| | Name of | Content of NAL unit and | NAL unit |
|---|---|---|---|
| nal_unit_type | nal_unit_type | RBSP syntax structure | type class |
| 0-5 | ( . . . ) | ( . . . ) | VCL |
| 6-20 | ( . . . ) | ( . . . ) | Non VCL |
| 21-23 | RSV | Reserved | Non VCL |
| 24-31 | UNSPEC | Unspecified | Non VCL |

The HEVC NALU header is defined in ISO/IEC 23008-2, Sec. 7.3.1.2, with the following syntax:

TABLE 3
HEVC NALU header syntax

| Syntax | Descriptor |
|---|---|
| nal_unit_header( ) { | |
| forbidden_zero_bit | f(1) |
| nal_unit_type | u(6) |
| nuh layer_id | u(6) |
| nuh_temporal_id_plus1 | u(3) |
| } | |

The NALU type values and semantics for HEVC are specified in Table 7-1 of the HEVC specification (IS 23008-2). Table 4 summarizes the usage of the HEVC NALU types. Since the HEVC NALU type is a field of 6 bits, the possible values are from 0 to 63. In this case, values of 41 to 47 are “reserved” and values of 48 to 63 are “unspecified”.

TABLE 4
HEVC NALU types

| | Name of | Content of NAL unit and | NAL unit |
|---|---|---|---|
| nal_unit_type | nal_unit_type | RBSP syntax structure | type class |
| 0-21 | ( . . . ) | ( . . . ) | VCL |
| 22-31 | RSV | Reserved | VCL |
| 32-40 | ( . . . ) | ( . . . ) | Non VCL |
| 41-47 | RSV | Reserved | Non VCL |
| 48-63 | UNSPEC | Unspecified | Non VCL |

The VVC NALU header is defined in ISO/IEC 23090-3, Sec. 7.3.1.2, with the

TABLE 5
VVC NAL unit header syntax

| Syntax | Descriptor |
|---|---|
| nal_unit_header( ) { | |
| forbidden_zero_bit | f(1) |
| nuh_reserved_zero_bit | u(1) |
| nuh_layer_id | u(6) |
| nal_unit_type | u(5) |
| nuh_temporal_id_plus1 | u(3) |
| } | |

The NALU type values and semantics for VVC are specified in Table 5 of the VVC specification (IS 23090-3). Table 6 summarizes the usage of the VVC NALU types. Since the VVC NALU type is a field of 5 bits, the possible values are from 0 to 31. In this case, values of 26 to 27 are “reserved” and values of 28 to 31 are “unspecified”. It may be seen from these tables that each video coding specification has a different range of “unspecified” values.

TABLE 6
VVC NALU types

| | Name of | Content of NAL unit and | NAL unit |
|---|---|---|---|
| nal_unit_type | nal_unit_type | RBSP syntax structure | type class |
| 0-11 | ( . . . ) | ( . . . ) | VCL |
| 12-25 | ( . . . ) | ( . . . ) | Non VCL |
| 26-27 | RSV | Reserved | Non VCL |
| 28-31 | UNSPEC | Unspecified | Non VCL |

The LCEVC NALU header is defined in ISO/IEC 23094-2, Sec. 7.3.2, with the following syntax:

TABLE 7
LCEVC NAL unit header

| Syntax | Descriptor |
|---|---|
| nal unit_header( ) { | |
| forbidden_zero_bit | u(1) |
| forbidden_one_bit | u(1) |
| nal_unit_type | u(5) |
| reserved_flag | u(9) |
| } | |

The NALU type values and semantics for LCEVC are specified in Table 17 of the LCEVC specification (IS 23094-2). Table 8 summarizes the usage of the LCEVC NALU types. Since the LCEVC NALU type is a field of 5 bits, the possible values are from 0 to 31.

TABLE 8
LCEVC NALU types

| | Name of | Content of NAL unit and | NAL unit |
|---|---|---|---|
| nal_unit_type | nal_unit_type | RBSP syntax structure | type class |
| 0-27 | UNSPEC | Unspecified | Non VCL |
| 28-29 | ( . . . ) | ( . . . ) | VCL |
| 30 | RSV | Reserved | Non VCL |
| 31 | UNSPEC | Unspecified | Non VCL |

As shown in the example of FIG. 2, when the base encoding is an MPEG standard, the elementary stream is a NAL unit stream. In this case, the encapsulation of enhancement data Access Units as metadata may be implemented using the SEI messages specific for each base coding specification. For example, AVC, HEVC and VVC each a different NAL unit format (e.g., with different NAL unit headers), breakdown of NALU types and payloads. However, all of these base coding specifications have an option of using SEI messages. SEI messages may comprise a NAL unit that is identified with a particular NAL unit type field (often referred to as nal_unit_type in the base coding specifications). An example of NAL unit types for SEI messages for AVC, HEVC, and VVC is set out in the table below, where RBSP stands for raw byte sequence payload:

TABLE 9
SEI NALU type

| MPEG | SEI | Corresponding |
|---|---|---|
| Standard | nal_unit_type | NAL unit payload |
| AVC | 6 | sei_rbsp( ) |
| HEVC | 39* | sei_rbsp( ) |
| WC | 23* | sei_rbsp( ) |

*prefix SEI

The SEI raw byte sequence payload (RBSP) and its inner syntax, for the purpose of enhancement encapsulation, is the same across the MPEG standards considered above. In one case, NAL units for an enhancement bitstream may be configured to, use a ITU-T T.35 user data registered type (user_data_registered_itu_t_t35 type) of SEI payload. For example, the general syntax of an SEI NAL unit is:

TABLE 10
General SEI RBSP format

| | |
|---|---|
| Descriptor | Value |

```
sei_rbsp( ) {
  do {
    sei_message( )
  } while( more_rbsp_data( ) )
  rbsp_trailing_bits( )
}
```

The syntax of a sei_message used to carry a ITU-T T.35 payload may be defined as shown in Table 11:

TABLE 11
SEI message syntax

| | Descriptor | Value |
|---|---|---|
| sei_message( ) { | | |
| payload_type_byte | u(8) | 0x04 |
| payloadType = payload_type_byte | | |
| payloadSize = 0 | | |
| do { | | |
| payload_size_byte | u(8) | |
| payloadSize += payload_size_byte | | |
| } while( payload_size_byte = = 0xFF ) | | |
| sei_payload( payloadType = 0x04, payloadSize ) | | |
| } | | |

The syntax of a user_data_registered_itu_t_t35 may follow the structure shown in Table 12.

TABLE 12
ITU-T T.35 syntax

| | |
|---|---|
| Descriptor | Value |

| | |
|---|---|
| user_data_registered_itu_t_t35( payloadSize ) { | |
| itu_t_t35_country_code | b(8) |
| if( itu_t_t35_country_code != 0xFF 1 | |
| i = 1 | |
| else { | |
| itu_t_t35_country_code_extension_byte | b(8) |
| i = 2 | |
| } | |
| do { | |
| itu_t_t35_payload_byte | b(8) |
| i++ | |
| } while( i < payloadSize ) | |
| } | |

In one case, for example where LCEVC is used as the enhancement layer specification, a manufacturer code may be used to identify a particular form of SEI message. For example, using a manufacturer code, a payload may have sei_payload(0x04, payloadSize)=user_data_registered_itu_t_t35 (payloadSize), with the following format:

TABLE 13
ITU-T T.35 syntax with the values specified
by an example manufacturer code

| | Descriptor | Value |
|---|---|---|
| user_data_registered_itu_t_t35( payloadSize ) { | | |
| itu_t_t35_country_code | b(8) | 0xB4 |
| itu_t_t35_payload_header { | | |
| t35_uk_country_code_second_octet | b(8) | 0x00 |
| t35_uk_manufacturer_code_first_octet | b(8) | 0x50 |
| t35_uk_manufacturer_code_second_octet | b(8) | 0x00 |
| } | | |
| i = 4 | | |
| do { | | |
| itu_t_t35_payload_byte | b(8) | |
| i++ | | |
| } while (i < payloadSize) | | |
| } | | |

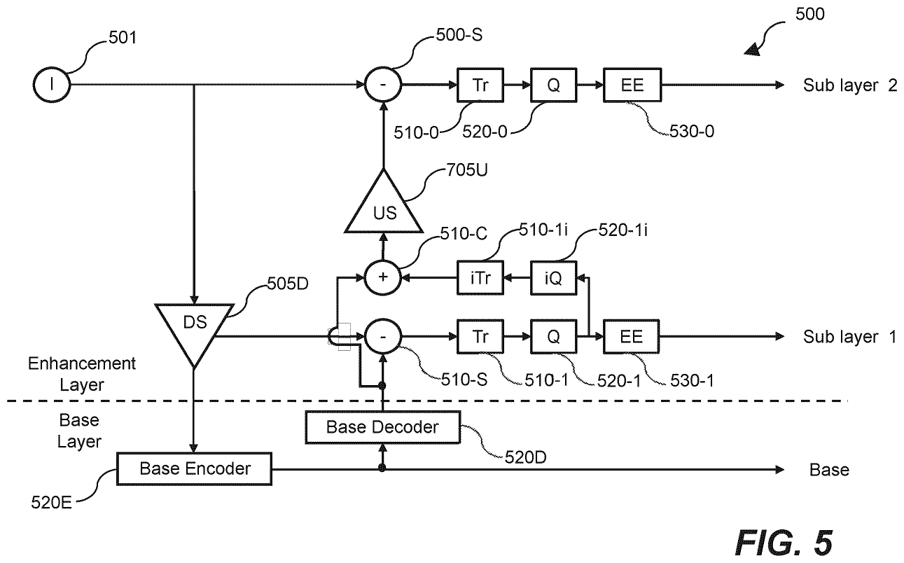

The specifications of the NAL unit header set out in the tables above are illustrated visually in the example 400 of FIG. 4. The top of the Figure shows the various sections of the NAL unit header for AVC, HEVC, and VVC. In general, a NAL unit header may be one or two bytes and the bits of these bytes are illustrated at 402 across the Figure. As can be seen, the NAL unit header for AVG is one byte where the NAL unit type field is carried by 5 bits—from bit 3 to bit 7 (inclusive). For HEVC, the NAL unit type is 6 bits carried from bit 1 to bit 6 (inclusive). In HEVC, bits 7 to 12 then carry a 6-bit layer identifier and bits 13 to 15 carry a temporal identifier. The layer and temporal identifier are internal fields for HEVC that are used for decoding according to that specification. VVC has a similar set of fields to HEVC, but the layer identifier is 6 bits that runs from bit 2 to but 7 (inclusive). The NAL unit type is a 5-bit field that runs from bit 8 to bit 12. Bits 12 to 15 then carry a 3-bit temporal identifier.

Given the variety of configurations of the NAL header shown in the upper part of FIG. 4, a set of configurations of the NAL header for the enhancement bitstream that are compatible with all three base video specifications (e.g., AVC, HEVC, and VVC) and the methods described herein are shown in the lower part of the Figure. Row 404 shows possible bit values for an enhancement bitstream NAL header that allow the NAL header to be of an “unspecified” type for all three base video specifications, despite each base vide specification having a different NAL header specification. In particular, in row 404, the first bit is 0, bits 1 to 4 and 7 to 15 are 1 and bits 5 and 6 are either 0 or 1. Row 406 shows bit values for an enhancement NAL unit where the NAL unit type is identified as 28 for LCEVC and row 408 shows bit values for an enhancement NAL unit where the NAL unit type is identified as 29 for LCEVC. Hence, for LCEVC, the two NALU type values used to identify video coding layer NAL units are 28 (=0x1C=0b1.1100), which specifies a non-IDR picture and 29 (=0x1 D=0b1.1101), which specifies an IDR picture. The two NAL unit header bytes for two video coding layer NAL unit types of LCEVC may thus be as follows:

0111.1001:1111.1111 (LCEVC NALU type 28 Non-IDR)
0111.1011:1111.1111 (LCEVC NALU type 29 IDR)

A summary of how a parser for each of AVC, HEVC, and VVC would interpret the bits of rows 406 and 408 is set out in the table below (where the first value relates to a parsing of row 406 and the second value relates to a parsing of row 408—e.g. 406|408):

TABLE 14
Parsed Values for Data in FIG. 4

| | NAL Unit Type | Layer ID | Temporal ID |
|---|---|---|---|
| AVC parser | 25\|27 | | |
| HEVC parser | 60\|61 | 63 | 7 |
| VVC parser | 31\|31 | 57\|59 | 7 |

As may be seen by comparing the table above and the specifications for AVC, HEVC, and VVC, the NAL unit types all fall within the “unspecified” ranges for each of AVC, HEVC, and VVC. For the AVC parser, the LCEVC NAL unit types (interpreted as 25 or 27) fall in the “unspecified” range from 24 to 31. For the HEVC parser, the LCEVC NALU types (interpreted as 60 or 61) fall in the “unspecified” range from 48 to 63. For the VVC parser, the LCEVC NALU types (interpreted as 31) fall in the “unspecified” range from 28 to 31. As such the enhancement NAL unit types are configured to avoid overlaps with NAL unit types of a used base video coding specification. In all three cases, the enhancement NAL unit header as parsed by a base decoder is detected as a NAL unit type in a defined “unspecified” range. In this way, a base parser which is unaware of an enhancement video coding specification such as LCEVC would continue classifying the enhancement NAL units as “unspecified”. To be aware of an enhancement bitstream, a base parser may be modified as described herein.

In particular, applying the method 300 of FIG. 3 to the example NAL header configurations of FIG. 4, the operation of an AVC, HEVC and VVC parser may be modified in the following manner to correctly recognize enhancement NAL units. For example, the behaviour of an LCEVC-aware AVC parser may be modified to perform the following logic:

if nal_unit_type = 25: treat as LCEVC_NON_IDR;
else if nal_unit_type = 27: treat as LCEVC_IDR;
else: treat as per AVC (ISO/IEC 14496-10 standard).

Here, LCEVC_NON_IDR is a flag indicating an LCEVC non-IDR picture and LCEVC_IDR is a flag indicating an LCEVC IDR picture. Similarly, the behaviour of an LCEVC-aware HEVC parser may be modified to perform the following logic:

if nal_unit_type = 60: treat as LCEVC_NON_IDR;
else if nal_unit_type = 61: treat as LCEVC_IDR;
else: treat as per HEVC (ISO/IEC 23008-2 standard).

For VVC, the behaviour of an LCEVC-aware VVC parser may be modified to perform the following logic:

```
if nuh_reserved_zero_bit = 1 and nal_unit_type = 31:
  if nuh_layer_id = 61: treat as LCEVC_NON_IDR;
  else if nuh_layer_id = 63: treat as LCEVC_IDR;
    else discard;
else: treat as per VVC (ISO/IEC 23090-3 standard).
```

In this case, the method is adapted such that a given NAL unit is discarded responsive to values for additional base layer metadata within the header data falling outside of a predefined range, where the base layer metadata comprises the layer identifier. An additional check is also made on a value of a reserved zero flag prior to instructing the decoding of the payload of the given NAL unit according to the enhancement layer specification.
Certain general information relating to example enhancement coding schemes will now be described. This information provides examples of specific multi-layer coding schemes.

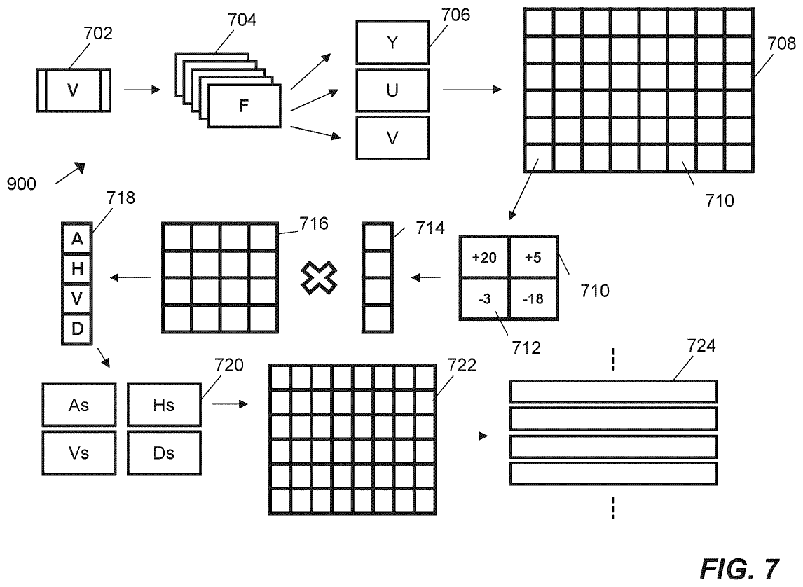

It should be noted that examples are presented herein with reference to a signal as a sequence of samples (i.e., two-dimensional images, video frames, video fields, sound frames, etc.). For simplicity, non-limiting examples illustrated herein often refer to signals that are displayed as 2D planes of settings (e.g., 2D images in a suitable colour space), such as for instance a video signal. In a preferred case, the signal comprises a video signal. An example video signal is described in more detail with reference to FIG. 7.

The terms “picture”, “frame” or “field” are used interchangeably with the term “image”, so as to indicate a sample in time of the video signal: any concepts and methods illustrated for video signals made of frames (progressive video signals) can be easily applicable also to video signals made of fields (interlaced video signals), and vice versa. Despite the focus of examples illustrated herein on image and video signals, people skilled in the art can easily understand that the same concepts and methods are also applicable to any other types of multidimensional signal (e.g., audio signals, volumetric signals, stereoscopic video signals, 3DoF/6DoF video signals, plenoptic signals, point clouds, etc.). Although image or video coding examples are provided, the same approaches may be applied to signals with dimensions fewer than two (e.g., audio or sensor streams) or greater than two (e.g., volumetric signals).

In the description the terms “image”, “picture” or “plane” (intended with the broadest meaning of “hyperplane”, i.e., array of elements with any number of dimensions and a given sampling grid) will be often used to identify the digital rendition of a sample of the signal along the sequence of samples, wherein each plane has a given resolution for each of its dimensions (e.g., X and Y), and comprises a set of plane elements (or “element”, or “pel”, or display element for two-dimensional images often called “pixel”, for volumetric images often called “voxel”, etc.) characterized by one or more “values” or “settings” (e.g., by ways of non-limiting examples, colour settings in a suitable colour space, settings indicating density levels, settings indicating temperature levels, settings indicating audio pitch, settings indicating amplitude, settings indicating depth, settings indicating alpha channel transparency level, etc.). Each plane element is identified by a suitable set of coordinates, indicating the integer positions of said element in the sampling grid of the image. Signal dimensions can include only spatial dimensions (e.g., in the case of an image) or also a time dimension (e.g., in the case of a signal evolving over time, such as a video signal). In one case, a frame of a video signal may be seen to comprise a two-dimensional array with three colour component channels or a three-dimensional array with two spatial dimensions (e.g., of an indicated resolution—with lengths equal to the respective height and width of the frame) and one colour component dimension (e.g., having a length of 3). In certain cases, the processing described herein is performed individually to each plane of colour component values that make up the frame. For example, planes of pixel values representing each of Y, U, and V colour components may be processed in parallel using the methods described herein.

Certain examples described herein use a scalability framework that uses a base encoding and an enhancement encoding. The video coding systems described herein operate upon a received decoding of a base encoding (e.g., frame-by-frame or complete base encoding) and add one or more of spatial, temporal, or other quality enhancements via an enhancement layer. The base encoding may be generated by a base layer, which may use a coding scheme that differs from the enhancement layer, and in certain cases may comprise a legacy or comparative (e.g., older) coding standard.

FIG. 5 to 7 show a spatially scalable coding scheme that uses a down-sampled source signal encoded with a base codec, adds a first level of correction or enhancement data to the decoded output of the base codec to generate a corrected picture, and then adds a further level of correction or enhancement data to an up-sampled version of the corrected picture. Thus, the spatially scalable coding scheme may generate an enhancement stream with two spatial resolutions (higher and lower), which may be combined with a base stream at the lower spatial resolution.

In the spatially scalable coding scheme, the methods and apparatuses may be based on an overall algorithm which is built over an existing encoding and/or decoding algorithm (e.g., MPEG standards such as AVC/H.264, HEVC/H.265, etc. as well as non-standard algorithms such as VP9, AV1, and others) which works as a baseline for an enhancement layer. The enhancement layer works accordingly to a different encoding and/or decoding algorithm. The idea behind the overall algorithm is to encode/decode hierarchically the video frame as opposed to using block-based approaches as done in the MPEG family of algorithms. Hierarchically encoding a frame includes generating residuals for the full frame, and then a reduced or decimated frame and so on.

FIG. 5 shows a system configuration for an example spatially scalable encoding system 500. The encoding process is split into two halves as shown by the dashed line. Each half may be implemented separately. Below the dashed line is a base level and above the dashed line is the enhancement level, which may usefully be implemented in software. The encoding system 500 may comprise only the enhancement level processes, or a combination of the base level processes and enhancement level processes as needed. The encoding system 500 topology at a general level is as follows. The encoding system 500 comprises an input I for receiving an input signal 501. The input I is connected to a down-sampler 505D. The down-sampler 505D outputs to a base encoder 520E at the base level of the encoding system 500. The down-sampler 505D also outputs to a residual generator 510-S. An encoded base stream is created directly by the base encoder 520E, and may be quantised and entropy encoded as necessary according to the base encoding scheme. The encoded base stream may be the base layer as described above, e.g. a lowest layer in a multi-layer coding scheme.

Above the dashed line is a series of enhancement level processes to generate an enhancement layer of a multi-layer coding scheme. In the present example, the enhancement layer comprises two sub-layers. In other example, one or more sub-layers may be provided. In FIG. 5, to generate an encoded sub-layer 1 enhancement stream, the encoded base stream is decoded via a decoding operation that is applied at a base decoder 520D. In preferred examples, the base decoder 520D may be a decoding component that complements an encoding component in the form of the base encoder 520E within a base codec. In other examples, the base decoding block 520D may instead be part of the enhancement level. Via the residual generator 510-S, a difference between the decoded base stream output from the base decoder 520D and the down-sampled input video is created (i.e., a subtraction operation 510-S is applied to a frame of the down-sampled input video and a frame of the decoded base stream to generate a first set of residuals). Here, residuals represent the error or differences between a reference signal or frame and a desired signal or frame. The residuals used in the first enhancement level can be considered as a correction signal as they are able to ‘correct’ a frame of a future decoded base stream. This is useful as this can correct for quirks or other peculiarities of the base codec. These include, amongst others, motion compensation algorithms applied by the base codec, quantisation and entropy encoding applied by the base codec, and block adjustments applied by the base codec.

In FIG. 5, the first set of residuals are transformed, quantised and entropy encoded to produce the encoded enhancement layer, sub-layer 1 stream. In FIG. 5, a transform operation 510-1 is applied to the first set of residuals; a quantisation operation 520-1 is applied to the transformed set of residuals to generate a set of quantised residuals; and, an entropy encoding operation 530-1 is applied to the quantised set of residuals to generate the encoded enhancement layer, sub-layer 1 stream (e.g., at a first level of enhancement). However, it should be noted that in other examples only the quantisation step 520-1 may be performed, or only the transform step 510-1. Entropy encoding may not be used, or may optionally be used in addition to one or both of the transform step 510-1 and quantisation step 520-1. The entropy encoding operation can be any suitable type of entropy encoding, such as a Huffmann encoding operation or a run-length encoding (RLE) operation, or a combination of both a Huffmann encoding operation and a RLE operation (e.g., RLE then Huffmann or prefix encoding).

To generate the encoded enhancement layer, sub-layer 2 stream, a further level of enhancement information is created by producing and encoding a further set of residuals via residual generator 500-S. The further set of residuals are the difference between an up-sampled version (via up-sampler 505U) of a corrected version of the decoded base stream (the reference signal or frame), and the input signal 501 (the desired signal or frame).

To achieve a reconstruction of the corrected version of the decoded base stream as would be generated at a decoder (e.g., as shown in FIG. 6), at least some of the sub-layer 1 encoding operations are reversed to mimic the processes of the decoder, and to account for at least some losses and quirks of the transform and quantisation processes. To this end, the first set of residuals are processed by a decoding pipeline comprising an inverse quantisation block 520-1i and an inverse transform block 510-1i. The quantised first set of residuals are inversely quantised at inverse quantisation block 520-1i and are inversely transformed at inverse transform block 510-1i in the encoding system 500 to regenerate a decoder-side version of the first set of residuals. The decoded base stream from decoder 520D is then combined with the decoder-side version of the first set of residuals (i.e., a summing operation 510-C is performed on the decoded base stream and the decoder-side version of the first set of residuals). Summing operation 510-C generates a reconstruction of the down-sampled version of the input video as would be generated in all likelihood at the decoder—i.e. a reconstructed base codec video). The reconstructed base codec video is then up-sampled by up-sampler 505U. Processing in this example is typically performed on a frame-by-frame basis. Each colour component of a frame may be processed as shown in parallel or in series.

The up-sampled signal (i.e., reference signal or frame) is then compared to the input signal 501 (i.e., desired signal or frame) to create the further set of residuals (i.e., a difference operation is applied by the residual generator 500-S to the up-sampled re-created frame to generate a further set of residuals). The further set of residuals are then processed via an encoding pipeline that mirrors that used for the first set of residuals to become an encoded enhancement layer, sub-layer 2 stream (i.e., an encoding operation is then applied to the further set of residuals to generate the encoded further enhancement stream). In particular, the further set of residuals are transformed (i.e., a transform operation 510-0 is performed on the further set of residuals to generate a further transformed set of residuals). The transformed residuals are then quantised, and entropy encoded in the manner described above in relation to the first set of residuals (i.e., a quantisation operation 520-0 is applied to the transformed set of residuals to generate a further set of quantised residuals; and, an entropy encoding operation 530-0 is applied to the quantised further set of residuals to generate the encoded enhancement layer, sub-layer 2 stream containing the further level of enhancement information). In certain cases, the operations may be controlled, e.g. such that, only the quantisation step 520-1 may be performed, or only the transform and quantisation step. Entropy encoding may optionally be used in addition. Preferably, the entropy encoding operation may be a Huffmann encoding operation or a run-length encoding (RLE) operation, or both (e.g., RLE then Huffmann encoding). The transformation applied at both blocks 510-1 and 510-0 may be a Hadamard transformation that is applied to 2×2 or 4×4 blocks of residuals.

The encoding operation in FIG. 5 does not result in dependencies between local blocks of the input signal (e.g., in comparison with many known coding schemes that apply inter or intra prediction to macroblocks and thus introduce macroblock dependencies). Hence, the operations shown in FIG. 5 may be performed in parallel on 4×4 or 2×2 blocks, which greatly increases encoding efficiency on multicore central processing units (CPUs) or graphical processing units (GPUs).

As illustrated in FIG. 5, the output of the spatially scalable encoding process is one or more enhancement streams for an enhancement layer which preferably comprises a first level of enhancement and a further level of enhancement. This is then combinable (e.g., via multiplexing or otherwise) with a base stream at a base level. The first level of enhancement (sub-layer 1) may be considered to enable a corrected video at a base level, that is, for example to correct for encoder quirks. The second level of enhancement (sub layer 2) may be considered to be a further level of enhancement that is usable to convert the corrected video to the original input video or a close approximation thereto. For example, the second level of enhancement may add fine detail that is lost during the downsampling and/or help correct from errors that are introduced by one or more of the transform operation 510-1 and the quantisation operation 520-1.

FIG. 6 shows a corresponding example decoding system 600 for the example spatially scalable coding scheme. In FIG. 6, the encoded base stream is decoded at base decoder 620 in order to produce a base reconstruction of the input signal 501. This base reconstruction may be used in practice to provide a viewable rendition of the signal 501 at the lower quality level. However, the primary purpose of this base reconstruction signal is to provide a base for a higher quality rendition of the input signal 501. To this end, the decoded base stream is provided for enhancement layer, sub-layer 1 processing (i.e., sub-layer 1 decoding). Sub-layer 1 processing in FIG. 6 comprises an entropy decoding process 630-1, an inverse quantisation process 620-1, and an inverse transform process 610-1. Optionally, only one or more of these steps may be performed depending on the operations carried out at corresponding block 500-1 at the encoder. By performing these corresponding steps, a decoded enhancement layer, sub-layer 1 stream comprising the first set of residuals is made available at the decoding system 600. The first set of residuals is combined with the decoded base stream from base decoder 620 (i.e., a summing operation 610-C is performed on a frame of the decoded base stream and a frame of the decoded first set of residuals to generate a reconstruction of the down-sampled version of the input video—i.e. the reconstructed base codec video). A frame of the reconstructed base codec video is then up-sampled by up-sampler 605U.

Additionally, and optionally in parallel, the encoded enhancement layer, sub-layer 2 stream is processed to produce a decoded further set of residuals. Similar to sub-layer 1 processing, enhancement layer, sub-layer 2 processing comprises an entropy decoding process 630-0, an inverse quantisation process 620-0 and an inverse transform process 610-0. Of course, these operations will correspond to those performed at block 500-0 in encoding system 500, and one or more of these steps may be omitted as necessary. Block 600-0 produces a decoded enhancement layer, sub-layer 2 stream comprising the further set of residuals, and these are summed at operation 600-C with the output from the up-sampler 605U in order to create an enhancement layer, sub-layer 2 reconstruction of the input signal 501, which may be provided as the output of the decoding system 800. Thus, as illustrated in FIGS. 5 and 6, the output of the decoding process may comprise up to three outputs: a base reconstruction, a corrected lower resolution signal and an original signal reconstruction for the multi-layer coding scheme at a higher resolution.

In general, examples described herein operate within encoding and decoding pipelines that comprises at least a transform operation. The transform operation may comprise the DCT or a variation of the DCT, a Fast Fourier Transform (FFT), or, in preferred examples, a Hadamard transform as implemented by LCEVC. The transform operation may be applied on a block-by-block basis. For example, an input signal may be segmented into a number of different consecutive signal portions or blocks and the transform operation may comprise a matrix multiplication (i.e., linear transformation) that is applied to data from each of these blocks (e.g., as represented by a 1D vector). In this description and in the art, a transform operation may be said to result in a set of values for a predefined number of data elements, e.g. representing positions in a resultant vector following the transformation. These data elements are known as transformed coefficients (or sometimes simply “coefficients”).

As described herein, where the enhancement data comprises residual data, a reconstructed set of coefficient bits may comprise transformed residual data, and a decoding method may further comprise instructing a combination of residual data obtained from the further decoding of the reconstructed set of coefficient bits with a reconstruction of the input signal generated from a representation of the input signal at a lower level of quality to generate a reconstruction of the input signal at a first level of quality. The representation of the input signal at a lower level of quality may be a decoded base signal and the decoded base signal may be optionally upscaled before being combined with residual data obtained from the further decoding of the reconstructed set of coefficient bits, the residual data being at a first level of quality (e.g., a first resolution). Decoding may further comprise receiving and decoding residual data associated with a second sub-layer, e.g. obtaining an output of the inverse transformation and inverse quantisation component, and combining it with data derived from the aforementioned reconstruction of the input signal at the first level of quality. This data may comprise data derived from an upscaled version of the reconstruction of the input signal at the first level of quality, i.e. an upscaling to the second level of quality.

Further details and examples of a two sub-layer enhancement encoding and decoding system may be obtained from published LCEVC documentation. Although examples have been described with reference to a tier-based hierarchical coding scheme in the form of LCEVC, the methods described herein may also be applied to other tier-based hierarchical coding scheme, such as VC-6: SMPTE VC-6 ST-2117 as described in PCT/GB2018/053552 and/or the associated published standard document, which are both incorporated by reference herein.

FIG. 7 shows an example 700 of how a video signal may be decomposed into different components and then encoded. In the example of FIG. 7, a video signal 702 is encoded. The video signal 702 comprises a plurality of frames or pictures 704, e.g. where the plurality of frames represent action over time. In this example, each frame 704 is made up of three colour components. The colour components may be in any known colour space. In FIG. 7, the three colour components 706 are Y (luma), U (a first chroma opponent colour) and V (a second chroma opponent colour). Each colour component may be considered a plane 708 of values. The plane 708 may be decomposed into a set of n by n blocks of signal data 710. For example, in LCEVC, n may be 2 or 4; in other video coding technologies n may be 8 to 32.

In LCEVC and certain other coding technologies, a video signal fed into a base layer is a downscaled version of the input video signal, e.g. 501. In this case, the signal that is fed into both sub-layers of the enhancement layer comprises a residual signal comprising residual data. A plane of residual data may also be organised in sets of n-by-n blocks of signal data 710. The residual data may be generated by comparing data derived from the input signal being encoded, e.g. the video signal 501, and data derived from a reconstruction of the input signal, the reconstruction of the input signal being generated from a representation of the input signal at a lower level of quality. The comparison may comprise subtracting the reconstruction from the downsampled version. The comparison may be performed on a frame-by-frame (and/or block-by-block) basis. The comparison may be performed at the first level of quality; if the base level of quality is below the first level of quality, a reconstruction from the base level of quality may be upscaled prior to the comparison. In a similar manner, the input signal to the second sub-layer, e.g. the input for the second sub-layer transformation and quantisation component, may comprise residual data that results from a comparison of the input video signal 501 at the second level of quality (which may comprise a full-quality original version of the video signal) with a reconstruction of the video signal at the second level of quality. As before, the comparison may be performed on a frame-by-frame (and/or block-by-block) basis and may comprise subtraction. The reconstruction of the video signal may comprise a reconstruction generated from the decoded decoding of the encoded base bitstream and a decoded version of the first sub-layer residual data stream. The reconstruction may be generated at the first level of quality and may be upsampled to the second level of quality.

Hence, a plane of data 708 for the first sub-layer may comprise residual data that is arranged in n-by-n signal blocks 710. One such 2 by 2 signal block is shown in more detail in FIG. 7 (n is selected as 2 for ease of explanation) where for a colour plane the block may have values 712 with a set bit length (e.g., 8 or 16-bit). Each n-by-n signal block may be represented as a flattened vector 714 of length n² representing the blocks of signal data. To perform the transform operation, the flattened vector 714 may be multiplied by a transform matrix 716 (i.e., the dot product taken). This then generates another vector 718 of length n² representing different transformed coefficients for a given signal block 710. FIG. 7 shows an example similar to LCEVC where the transform matrix 716 is a Hadamard matrix of size 4 by 4, resulting in a transformed coefficient vector 718 having four elements with respective values. These elements are sometimes referred to by the letters A, H, V and D as they may represent an average, horizontal difference, vertical difference and diagonal difference. Such a transform operation may also be referred to as a directional decomposition. When n=4, the transform operation may use a 16 by 16 matrix and be referred to as a directional decomposition squared.

As shown in FIG. 7, the set of values for each data element across the complete set of signal blocks 710 for the plane 708 may themselves be represented as a plane or surface of coefficient values 720. For example, values for the “H” data elements for the set of signal blocks may be combined into a single plane, where the original plane 708 is then represented as four separate coefficient planes 722. For example, the illustrated coefficient plane 722 contains all the “H” values. These values are stored with a predefined bit length, e.g. a bit length B, which may be 8, 16, 32 or 64 depending on the bit depth. A 16-bit example is considered below but this is not limiting. As such, the coefficient plane 722 may be represented as a sequence (e.g., in memory) of 16-bit or 2-byte values 724 representing the values of one data element from the transformed coefficients. These may be referred to as coefficient bits. These coefficient bits may be quantised and then entropy encoded as discussed to then generate the encoded enhancement layer data as described above.

In certain cases, example method 300 or any other of the examples described herein may be implemented via instructions retrieved from a computer-readable medium. These may be executed by a processor of a decoding system, such as a client device. The techniques described herein may be implemented in software or hardware, or may be implemented using a combination of software and hardware. They may include configuring an apparatus to carry out and/or support any or all of techniques described herein. The above examples are to be understood as illustrative. Further examples are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

1. A method of parsing a multi-layer video stream, the multi-layer video stream encoding a video signal and comprising a base layer and one or more enhancement layers, the base layer being encoded using a base layer specification, the one or more enhancement layers being encoded using an enhancement layer specification and comprising one or more sets of frame residuals, a set of frame residuals comprising a difference between a reconstruction derived from a decoded base layer frame and a frame derived from an original video signal at a given level of quality, the method comprising:
at a modified parser for the base layer, parsing header data for Network Abstraction Layer (NAL) units belonging to the multi-layer video stream, including, for a given NAL unit:
extracting a NAL unit type value from the header data for the given NAL unit;
responsive to the NAL unit type value falling within a specified range for the base layer specification, instructing the decoding of a payload of the given NAL unit according to the base layer specification; and
responsive to the NAL unit type value falling within a predetermined portion of an unspecified range for the base layer specification,
determining an enhancement layer NAL unit type from the header data, and
instructing the decoding of the payload of the given NAL unit according to the enhancement layer specification based on the determined enhancement layer NAL unit type.

2. The method of claim 1, wherein the enhancement layer NAL unit type indicates whether the given NAL unit is associated with an instantaneous decoding refresh picture.

3. The method of claim 2, wherein the method further comprises:
responsive to the enhancement layer NAL unit type indicating an instantaneous decoding refresh picture, extracting global configuration data from the payload of the given NAL unit, and using the global configuration data to decode a plurality of residual frames, data for the plurality of residual streams being distributed across multiple NAL units in the multi-layer video stream.

4. The method of claim 1, wherein the base layer specification is one of Advanced Video Coding (AVC), High Efficiency Video Coding (HEVC), and Versatile Video Coding (WC), and the enhancement layer specification is Low Complexity Enhancement Video Coding (LCEVC).

5. The method of claim 1, wherein NAL units for the base layer are interleaved with NAL units for the one or more enhancement layers within the multi-layer video stream.

6. The method of claim 1, wherein the header data comprises a 16-bit sequence, wherein bit values for NAL units belonging to the one or more enhancement layers are configured to indicate a value falling within the unspecified range for the base layer specification for a plurality of different base layer specifications.

7. The method of claim 1,
comprising: discarding the given NAL unit responsive to values for additional base layer metadata within the header data falling outside of a predefined set of metadata values.

8. The method of claim 7, wherein the base layer specification comprises Versatile Video Coding (WC) and the additional base layer metadata comprises a layer identifier.

9. The method of claim 8, wherein an additional check is made on a value of a reserved zero flag prior to instructing the decoding of the payload of the given NAL unit according to the enhancement layer specification.

10. A parser for parsing a video stream, the parser being configured to process Network Abstraction Layer (NAL) units comprising data encoded according to a first video coding specification, the parser comprising:
a memory to store header data from Network Abstraction Layer (NAL) units belonging to a video stream; and
a processor configured to:
extract a NAL unit type value from the header data for a given NAL unit; and
responsive to the NAL unit type value falling within a specified range for first video coding specification, instruct the decoding of a payload of the given NAL unit according to the first video coding specification,
wherein the parser is modified to process a multi-layer video stream, such that the processor is configured to, responsive to the NAL unit type value falling within a predetermined portion of an unspecified range for the first video coding specification:
determine an enhancement layer NAL unit type from the header data, and
instruct the decoding of the payload of the given NAL unit according to an enhancement layer specification based on the determined enhancement layer NAL unit type,
wherein a reconstruction of an original video signal associated with the multi-layer video stream is generated by combining data derived from frames decoded according to the first video coding specification with data derived from residual frames decoded according to the enhancement layer specification, each residual frame providing a quality improvement to a frame decoded according to the first video coding specification.

11. The parser of claim 10, wherein the enhancement layer NAL unit type indicates whether the given NAL unit is associated with an instantaneous decoding refresh picture.

12. The parser of claim 11, wherein the processor is further configured to, responsive to the enhancement layer NAL unit type indicating an instantaneous decoding refresh picture, instruct the extraction of global configuration data from the payload of the given NAL unit and instruct the use of the global configuration data to decode a plurality of residual frames, data for the plurality of residual streams being distributed across multiple NAL units in the multi-layer video stream.

13. The parser of claim 10, wherein the first video coding specification is one of Advanced Video Coding (AVC), High Efficiency Video Coding (HEVC), and Versatile Video Coding (WC), and the enhancement layer specification is Low Complexity Enhancement Video Coding (LCEVC).

14. The parser of claim 10, wherein NAL units for the first video coding specification are interleaved with NAL units for the enhancement layer specification within the multi-layer video stream.

15. The parser of claim 10, wherein the header data comprises a 16-bit sequence, wherein bit values for NAL units belonging to one or more enhancement layers are configured to indicate a value falling within the unspecified range for the first video coding specification for a plurality of different first video coding specifications.

16. The parser of claim 10, wherein the parser is configured to discard the given NAL unit responsive to values for additional base layer metadata within the header data falling outside of a predefined range.

17. The parser of claim 16, wherein the first video coding specification comprises Versatile Video Coding (WC) and the additional base layer metadata comprises a layer identifier.

18. The parser of claim 17, wherein an additional check is made on a value of a reserved zero flag prior to instructing the decoding of the payload of the given NAL unit according to the enhancement layer specification.

19. A computer-readable medium comprising instructions which when executed cause a processor to perform the method of claim 1.
